(19) United States
(12) Patent Application Publication
(10) Pub. No.: US 2015/0187523 A1
(43) Pub. Date: Jul. 2, 2015

(54) SYSTEM CABLING FOR A MULTIPLE RELAY ARRANGEMENT

(71) Applicants: Markus Becker, Paderborn (DE); Heinrich Heise, Horn-Bad Meinberg (DE); Christoph Leifer, Bad Driburg (DE); Andreas Woehrmeier, Doerentrup (DE)

(72) Inventors: Markus Becker, Paderborn (DE); Heinrich Heise, Horn-Bad Meinberg (DE); Christoph Leifer, Bad Driburg (DE); Andreas Woehrmeier, Doerentrup (DE)

(73) Assignee: PHOENIX CONTACT GMBH & CO. KG, Blomberg (DE)

(21) Appl. No.: 14/117,066

(22) PCT Filed: May 15, 2012
(86) PCT No.: PCT/EP2012/002075

§ 371 Date: Jul. 3, 2014

(30) Foreign Application Priority Data
May 16, 2011 (DE) 10 2011 101 686.8

(51) Int. Cl. H01H 45/14; H01B 7/08

(52) U.S. Cl. CPC H01H 45/14; H01B 7/08; H01H 2207/022

(57) ABSTRACT

A multiple relay arrangement having a plurality of relay sockets which are arranged next to each other and a plurality of relays. The relay sockets contain additional plug connections with which the relays are controlled by the system cabling. The system cabling contains a distribution section having cable sections and plug connectors and allows the plurality of relays to be controlled.

The invention relates to a multiple relay arrangement with a plurality of relay sockets, which are arranged next to each other, and which can have varying dimensions, in order to also accommodate different relays. Each relay socket has a relay plug connector, input and output connections and an at least bipolar additional plug connector for additional electronics, and can be plugged onto a mounting rail.

A plug-in mounting with two-part connection part having respective contact reeds to fix connecting cables or wires in the plug-in mounting using a plug part and screw fixings is known from DE 39 23 137 C1. Such plug-in mountings can be fixed next to each other on a rail and bridging brackets between the plug-in mountings ensure neutral conductor connections (DE 42 33 722 A1).

Modules arranged in a row on a rail can be combined into module groups using 8-pole pin contacts (Dr. Hasberg Datentechnik, Elektronik fuer Industrie and Freizeit). The connection (system bus) between the module groups can be achieved with Cat. 5e patch cables with shielded connectors.

Relay sockets with additional bipolar plug connectors are known (EP 1 760 745 A2, relay socket series 788; company: WAGO) and serve to connect a visual display, for example.

Such relay sockets are normally arranged in rows in groups on a mounting rail and must be connected to control devices, distributor modules and similar. For this purpose, cable harnesses with individual wiring for the respective application case are used in practice. Also known in practice, however, are prefabricated cables with a group connector for a group of relay sockets arranged next to each other, which constitutes a type of system cabling. A disadvantage of this connecting system is the need to use relay sockets of equal width next to each other so that the connection with the group connector fits.

The object of the invention is to create system cabling for relay sockets which are arranged next to each other, in which the relay sockets can have varying dimensions in the longitudinal direction of the rail.

The abovementioned technical object is achieved by the features of claim 1. According to said claim a multiple relay arrangement is provided. It comprises a plurality of relay sockets, arranged next to each other, which are plugged onto a mounting rail, each having a relay plug connector, input and output connections for the relay and an at least bipolar additional plug connector for additional electronics, and can have varying dimensions in the longitudinal direction of the rail. Furthermore, the multiple relay arrangement comprises a plurality of relays, which are dimensioned so as to be received in associated relay plug connectors, as well as system cabling with a plurality of cable sections and with plug connectors, which are each designed to connect to an additional plug connector of a relay socket, in order to connect the relays electrically to a control device.

The invention takes advantage of standard relay sockets being equipped with an additional plug connector for additional electronics, which have access to the control input of the respective relay. The new type of system cabling is equipped with a plurality of plug connectors, which are each designed to connect to an additional plug connection of a respective relay socket in order to thus connect the relays to a control device or distributor module or similar. Between the plug connectors there are cable sections, which facilitate the bridging of different centre-to-centre distances of relay sockets. In this way the system cabling can be connected to a group of relay sockets, which are arranged next to each other, without the relay sockets having to have the same dimensions in the longitudinal direction of the rail

The system cabling can take the form of a cable harness with plug connectors included therein, which are connected to a multiple-pole connector via pairs of conductors of the cable.

A star-shaped arrangement of the pairs of conductors can be implemented between the multiple-pole connector and the individual plug connectors. It is, however, also possible to implement a serial arrangement of the pairs of conductors between the multiple-pole connector and the respective plug connectors.

It is particularly advantageous for the cable harness to use a pre-configured flat ribbon cable, which contains a conductor crossover point with conductor lead-outs for each connector. The cable sections of the system cabling correspond to the distance of the conductor crossover points from each other.

The additional electronics of a known type are accommodated inside a respective housing, which has a connector to interact with the additional plug connection of the relay socket. Such a housing with the additional electronics accommodated therein is integrated in the system cabling with the plug connector thereof. The additional electronics, which are known per se, comprise a suppressor circuit and/or status indicator for the relay, as required. The additional electronics can also constitute a free-wheeling diode, an RC combination or a varistor, for example.

Embodiments of the invention are described with reference to the drawings, in which:

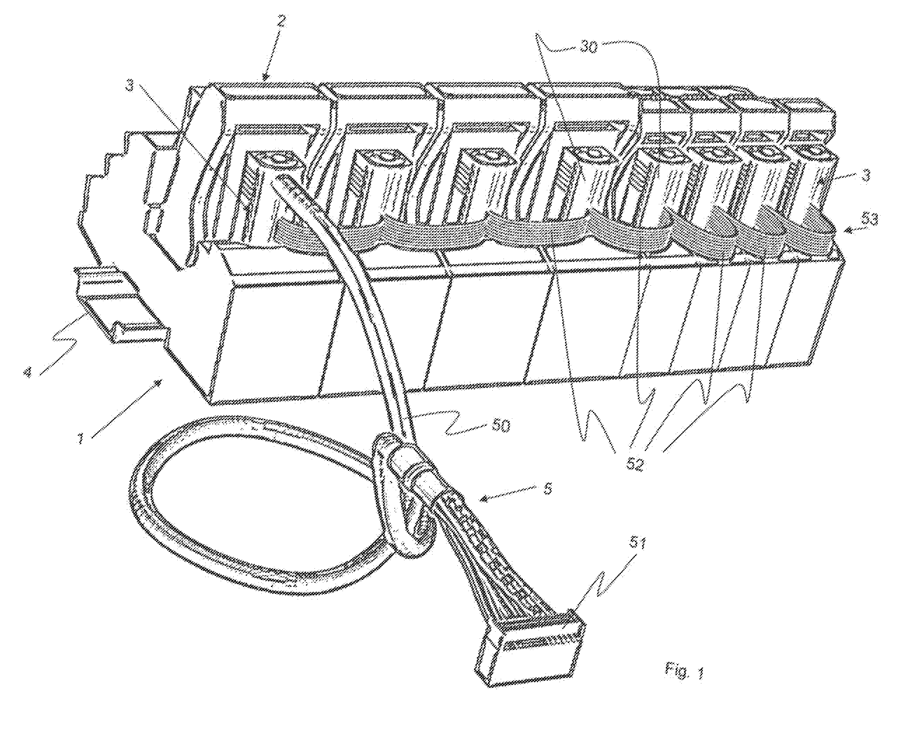

FIG. 1 shows a multiple relay arrangement with a cable harness in perspective view,

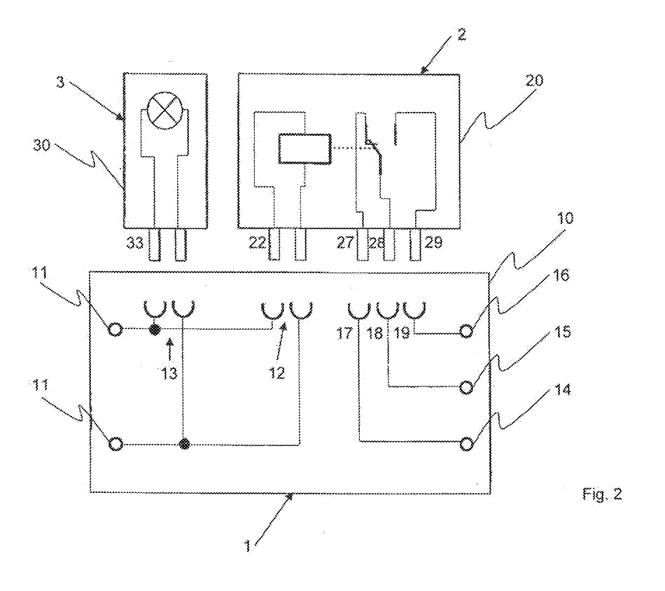

FIG. 2 shows a schematic view of a relay socket, a relay and additional electronics,

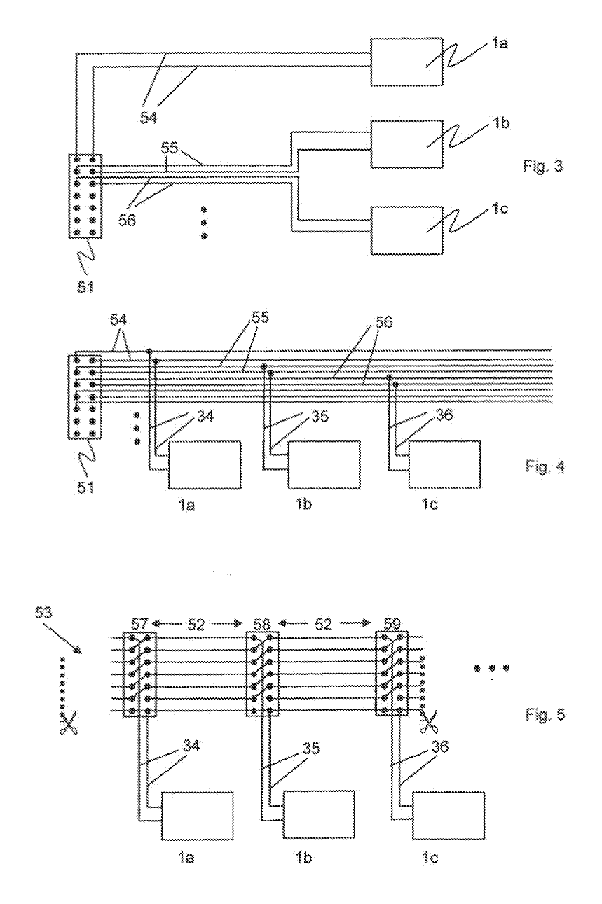

FIG. 3 shows a star-shaped arrangement of pairs of conductors of a cable harness,

FIG. 4 shows a serial arrangement of pairs of conductors of the cable harness,

FIG. 5 shows a pre-configured cable for use in the serial arrangement of the cable harness,

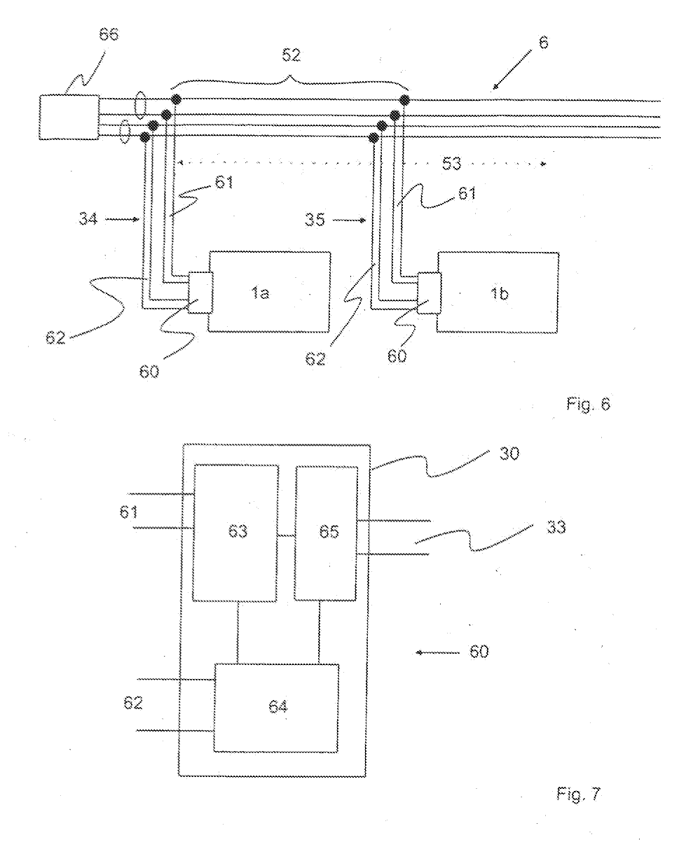

FIG. 6 shows a multiple relay arrangement, which can be controlled via bus signals, and

FIG. 7 shows the schematic arrangement of a connection module for the multiple relay arrangement according to FIG. 6.

FIG. 1 shows a multiple relay arrangement with eight units, which each comprise a relay socket 1, a relay 2 and additional electronics 3. The relay sockets 1 are plugged next to each other on a mounting rail 4 and are fixed in that position. The units comprising relay socket, relay and additional electronics constitute a group, which is controlled via system cabling in the form of a cable harness 5.

The schematic view of FIG. 2 shows the connections inside the relay socket 1, the relay 2 and the additional electronics 3. The relay socket, relay and additional electronics are accommodated inside the housings 10, 20 and 30 respectively, the design and dimensions of which are standardised. The relay socket 1 comprises input connections 11, which are connected to the relay 2 via wires with a connector 12 and to the additional electronics 3 with a connector 13. The relay socket 1 comprises three output connections 14, 15, 16, which are connected via wires with connectors 17, 18, 19, which lead to the output circuit of the relay 2. The input and output circuits of the relay 2 comprise mating plugs 22, 27, 28, 29 to form a plug connection with the corresponding connectors 12, 17, 18 and 19 of the relay socket 1. The internal construction of the relay 2, shown electromechanically here, can also be electronic, as known. The additional electronics 3 have a plug connector 33 to interact with the connector 13 of the relay socket 1.

The cable harness 5 comprises a supply cable 50, a multiple-pole connector 51 and a series of cable sections 52, which form a distributor section 53. The cable sections 52 are fed in curves, which extend between the individual housings 30 of the additional electronics 3 and connect them. In the case of the wider relay sockets 1 the curves of the cable sections 52 are wider and in the case of the narrower relay sockets 1 the curves are tighter. By selecting the length of the cable sections 52 accordingly, it can be ensured that any type of relay socket, whether wide or narrow, can be covered by one and the same system cabling.

FIG. 3 shows a star-shaped arrangement of the system cabling. Pairs of conductors 54, 55, 56 are shown, which lead from a multiple-pole connector 51 to the relay sockets 1a, 1b, 1c. The length of the pairs of conductors varies according to the length of the cable sections 52, which is not shown in FIG. 3.

FIG. 4 shows a serial arrangement of the system cabling. The pairs of conductors 54, 55, 56 are continuous but are tapped at the intervals of the cable sections 52, the branches 34, 35, 36 being located inside the respective housing 30 of the additional electronics 3 and leading to the respective connectors 33.

FIG. 5 shows the use of a pre-configured flat ribbon cable to produce the distribution section 53. There are conductor crossover points 57, 58, 59, from which the branches 34, 35, 36 lead to the plug connectors 13/33 and thus to the relay sockets 1a, 1b, 1c. The distance between the conductor crossover points 57, 58, 59 corresponds to the length of each cable section 52. The conductor crossover points 57, 58, 59 are each accommodated in a housing 30 of the additional electronics, while the cable sections 52 extend outside this housing 30, as shown in FIG. 1.

The system cabling can be used in bus systems 6, which work with digital signals (FIG. 6). The bus system 6 comprises a gateway 66 on the input side and contains a distribution section 53 with cable sections 52 between which the branches 34, 35 lead to connection modules 60.

The branches 34, 35 comprise signal wires 61 and power supply wires 62, which lead to the respective plug connector 33 of the relay socket 19, 16.

FIG. 7 schematically shows the arrangement of a connection module 60, which is accommodated in a housing 30. A signal processing device 63, a power conditioning device 64, and a driver stage 65 for controlling the associated relay 2 are provided. The plug connectors 33 lead to the relay socket 1 and the associated relay 2, as in the case of FIG. 2.

The invention thus provides system cabling in which the relay 2 can be controlled via the connections 33, which can otherwise be used for additional electronics 3. A type of cable harness 5 is used, which has a connection section 50 and a distribution section 53 with a series of cable sections 52 of a certain length, which make it possible to operate groups of relay sockets 1, which can also be of varying widths.

1. A multiple relay arrangement, comprising:
(a) a plurality of relay sockets, which relay sockets
(a-1) are arranged next to each other, and
(a-2) are plugged onto a mounting rail,
(a-3) are configured to be able to have varying dimensions in a longitudinal direction of the mounting rail,
(a-4) each include an input plug connector configured for input of a respective relay, an output plug connector configured for output of the respective relay,
a control input connection configured for the respective relay. an output connection configured for the respective relay, and
(a-5) an at least bipolar additional plug connection configured for additional electronics, which additional plug connection is located parallel to the control input connection and is connected to the input plug connector to the respective relay;
(b) a plurality of the relays, which are plugged as a group next to each other into the associated input plug connectors and output plug connectors; and
(c) system cabling configured to control the relays, which system cabling includes a plurality of cable sections and plug connectors,
wherein the plug connectors are plugged into the additional plug connections of the relay sockets and the cable sections,
wherein the cable sections bridge gaps between the additional connections.

2. The multiple relay arrangement of claim 1, wherein the system cabling further includes a cable harness, a supply cable, and a distribution section,
wherein the distribution section is configured to supply the relay groups, and
wherein the system cabling is constructed of pairs of conductors and plug connectors included therein.

3. The multiple relay arrangement of claim 2, wherein the pairs of conductors are connected via branches to the respective plug connectors.

4. The multiple relay arrangement of claim 3, wherein the branches are accommodated inside housings of the additional electronics.

5. The multiple relay arrangement of claim 2, wherein a star-shaped arrangement of the pairs of conductors is implemented between a multiple-pole connector and the individual plug connectors.

6. The multiple relay arrangement of claim 2, wherein a serial arrangement of the pairs of conductors is implemented between a multiple-pole connector and the individual plug connectors.

7. The multiple relay arrangement of claim 6, wherein the cable harness includes a pre-configured flat ribbon cable as a distribution section,
wherein the flat ribbon cable includes a conductor crossover point with a conductor lead-through for each plug connector used.

8. The multiple relay arrangement of claim 1, wherein at least one of the plug connectors is connected to a housing and the additional electronics accommodated in the housing.

9. The multiple relay arrangement of claim 1, wherein the additional electronics include a suppressor circuit.

10. The multiple relay arrangement of claim 1, wherein the additional electronics include a free-wheeling diode.

11. The multiple relay arrangement of claim 1, wherein the additional electronics include an RC combination.

12. The multiple relay arrangement of claim 1, wherein the additional electronics include a timer circuit.

13. The multiple relay arrangement of claim 1, wherein the system cabling includes a bus system including a distribution section configured to supply the relay group,
wherein the distribution section is divided into cable sections from which branches lead to the connection modules to which the relay sockets and relays are assigned.

14. The multiple relay arrangement of claim 1, wherein the additional electronics include a status indicator of the relay.

15. The multiple relay arrangement of claim 9, wherein the additional electronics include a status indicator of the relay.

16. The multiple relay arrangement of claim 9, wherein the additional electronics include a free-wheeling diode.

17. The multiple relay arrangement of claim 9, wherein the additional electronics include an RC combination.

18. The multiple relay arrangement of claim 9, wherein the additional electronics include a timer circuit.
